(19) United States
(12) Patent Application Publication
(10) Pub. No.: US 2026/0203512 A1
(43) Pub. Date: Jul. 16, 2026

(54) Video Reconstruction Using Geodesically-Constrained Latent Expansion Networks

(71) Applicant: AtomBeam Technologies Inc., Moraga, CA (US)

(72) Inventor: Brian Galvin, Silverdale, WA (US)

(21) Appl. No.: 19/383,734

(22) Filed: Nov. 9, 2025

Related U.S. Application Data
(63) Continuation-in-part of application No. 19/379,579, filed on Nov. 4, 2025.
Application No. 19/379,579 is a continuation-in-part of application No. 19/378,949, filed on Nov. 4, 2025.
Application No. 19/378,949 is a continuation-in-part of application No. 19/377,013, filed on Nov. 2, 2025.
Application No. 19/377,013 is a continuation-in-part of application No. 19/352,457, filed on Oct. 7, 2025.
Application No. 19/352,457 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/051,193 is a continuation-in-part of application No. 19/038,801, filed on Jan. 28, 2025.
Application No. 19/038,801 is a continuation of application No. 18/818,593, filed on Aug. 29, 2024, now Pat. No. 12,308,862.
Application No. 18/818,593 is a continuation-in-part of application No. 18/657,719, filed on May 7, 2024, now Pat. No. 12,166,506.
Application No. 18/657,719 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 19/377,013 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 19/378,949 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/379,579 is a continuation-in-part of application No. 19/363,675, filed on Oct. 21, 2025.
Application No. 19/363,675 is a continuation-in-part of application No. 19/351,286, filed on Oct. 6, 2025.
Application No. 19/351,286 is a continuation-in-part of application No. 19/321,173, filed on Sep. 6, 2025, now Pat. No. 12,602,549.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
(63) Continuation-in-part of application No. 19/329,369, filed on Sep. 15, 2025.
Application No. 19/329,369 is a continuation-in-part of application No. 19/328,199, filed on Sep. 14, 2025.
Application No. 19/328,199 is a continuation-in-part of application No. 19/328,179, filed on Sep. 14, 2025.
Application No. 19/328,179 is a continuation-in-part of application No. 19/326,730, filed on Sep. 12, 2025, now Pat. No. 12,608,555.
Application No. 19/328,199 is a continuation of application No. 19/328,103, filed on Sep. 13, 2025, now Pat. No. 12,639,521.
Application No. 19/328,103 is a continuation-in-part of application No. 19/326,730, filed on Sep. 12, 2025, now Pat. No. 12,608,555.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,969, filed on Jul. 21, 2025.
(60) Provisional application No. 63/847,889, filed on Jul. 21, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method of video reconstruction compresses video into curved latent manifold representations using Lorentzian autoencoder processing that preserves temporal causality and spatial relationships. The system organizes compressed representations hierarchically across multiple resolution scales, then computes mathematically valid expansion trajectories extending beyond original encoded boundaries. Expansions follow geodesic paths determined by minimizing an action functional balancing kinetic energy, compression pressure from manifold curvature, and semantic goal potentials. Expanded trajectories are decoded into video content while maintaining coherence through geometric constraints. Energy budgeting manages computational resources to prevent uncontrolled generation. The system provides real-time reconstruction supporting infinite zoom beyond sensor resolution, counterfactual scenario synthesis, and cross-domain video generation, enabling coherent content generation beyond originally encoded material while preserving semantic consistency and temporal fidelity.

### CROSS-REFERENCE TO RELATED APPLICATIONS

Priority is claimed in the application data sheet to the following patents or patent applications, each of which is expressly incorporated herein by reference in its entirety:
Ser. No. 19/379,579
Ser. No. 19/378,949
Ser. No. 19/377,013
Ser. No. 19/352,457
Ser. No. 19/321,173
Ser. No. 19/284,115
Ser. No. 19/051,193
Ser. No. 63/847,082
Ser. No. 63/847,091
Ser. No. 63/847,096
Ser. No. 63/847,101
Ser. No. 63/847,969
Ser. No. 19/038,801
Ser. No. 18/818,593
Ser. No. 18/657,719
Ser. No. 18/410,980
Ser. No. 18/537,728
Ser. No. 19/326,730
Ser. No. 63/847,889
Ser. No. 19/245,366
Ser. No. 19/204,525
Ser. No. 19/192,215
Ser. No. 18/972,797
Ser. No. 18/648,340
Ser. No. 19/328,094
Ser. No. 19/363,675
Ser. No. 19/351,286
Ser. No. 18/427,716
Ser. No. 19/329,369
Ser. No. 19/328,199
Ser. No. 19/328,179
Ser. No. 19/328,103

### BACKGROUND OF THE INVENTION

### Field of the Art

The present invention relates to the field of video processing and computer vision, and more specifically to systems and methods for geodesically-constrained latent expansion of spatiotemporal media for reconstruction, augmentation, and infinite zoom beyond encoded resolution boundaries.

### Discussion of the State of the Art

Recent advances in video processing and computer vision have introduced deep learning architectures such as hierarchical autoencoders and correlation networks that improve compression, reconstruction, and augmentation of spatiotemporal media. These systems can preserve semantic structure across multiple scales, perform adaptive zoom within encoded resolution boundaries, and generate counterfactual variations of existing content. Techniques based on geometric deep learning have further enabled video representations to be organized within curved latent manifolds, allowing traversal across spatial, temporal, and semantic dimensions to support reconstruction and synthesis.

Despite these advances, current systems remain limited to operating within the regions that have been explicitly encoded. While they can navigate, interpolate, and augment within the boundaries of the latent representation, they lack mechanisms for mathematically valid expansion beyond those boundaries. Attempts to extrapolate beyond encoded content often produce semantic drift, temporal inconsistency, or uncontrolled generative behavior. Existing methods also fail to incorporate constrained variational optimization, attention field modeling, and energy budgeting in a unified framework that ensures expansions remain geometrically valid and semantically coherent.

What is needed is a system that enables geodesically constrained latent expansion beyond encoded boundaries, allowing video reconstruction and augmentation that preserves semantic fidelity, temporal consistency, and geometric integrity while supporting infinite zoom, counterfactual synthesis, and cross-domain generation.

### SUMMARY OF THE INVENTION

Accordingly, the inventor has conceived and reduced to practice a system and method for video reconstruction using geodesically-constrained latent expansion networks that enables coherent generation of video content beyond the boundaries of originally encoded material. The system compresses spatiotemporal video data into curved latent manifold representations using Lorentzian autoencoder processing, then computes mathematically valid expansion trajectories along geodesic paths that extend beyond encoded regions while maintaining semantic coherence and temporal consistency. Through constrained variational optimization that balances kinetic energy, compression pressure, and semantic goal potential, the system generates expanded video content supporting infinite zoom beyond sensor resolution, counterfactual scenario exploration, and cross-domain synthesis capabilities.

In an embodiment, a computer system comprises hardware memory configured to execute software instructions that receive spatiotemporal video input, encode the video into compressed latent representations within a curved latent manifold using Lorentzian autoencoder processing that preserves spatiotemporal structure and causal relationships, organize the compressed representations in a hierarchical manifold structure with nested submanifolds at multiple resolution scales, compute geodesic expansion trajectories extending beyond encoded representations through constrained variational optimization minimizing a cognitive action functional with kinetic energy terms, compression pressure from manifold curvature, and semantic goal potential fields, generate expanded video content by decoding latent trajectories along geodesic expansion paths while maintaining semantic coherence and temporal consistency through geometric constraints, manage computational resources through energy budgeting that allocates finite cognitive energy across expansion operations to prevent uncontrolled generative drift, and provide real-time video reconstruction and augmentation configured to output reconstructed or augmented video streams including zoom beyond original resolution, counterfactual synthesis, and cross-domain generation.

In an aspect of an embodiment, computing geodesic expansion trajectories involves applying spectral decomposition using eigenfunctions of a Laplace-Beltrami operator defined over the latent manifold to separate low-frequency semantic components from high-frequency detail components during expansion.

In an aspect of an embodiment, the hierarchical manifold structure includes projection operators that compress representations from micro-level to macro-level submanifolds and lifting operators that expand representations from macro-level to micro-level submanifolds while maintaining semantic consistency across resolution transitions.

In an aspect of an embodiment, attention is modeled as a continuous vector field evolving over the curved latent manifold according to fluid dynamics equations, with geodesic expansion trajectories computed to align with streamlines of the attention vector field.

In an aspect of an embodiment, cross-manifold communication is enabled through tunneling operators that map geodesic trajectories between distinct latent manifolds while preserving curvature properties and maintaining semantic anchor alignment.

In an aspect of an embodiment, counterfactual video sequences are generated by applying tangent-space perturbations to baseline geodesic trajectories, with perturbations constrained by curvature regularization and semantic anchor consistency requirements.

In an aspect of an embodiment, offline manifold reorganization is performed during idle periods by perturbing, compressing, and interpolating successful expansion trajectories to generate cached expansion strategies for accelerated real-time performance.

In an aspect of an embodiment, energy budgeting involves computing trajectory energy costs that integrate kinetic energy of latent traversal, compression pressure penalties, and curvature smoothness terms, with trajectories accepted only when total energy cost remains below a predetermined threshold.

In an embodiment, the methods of the geodesically-constrained latent expansion network system provide corresponding computer-implemented processes for video reconstruction and augmentation through mathematically constrained latent space expansion.

### BRIEF DESCRIPTION OF THE DRAWING FIGURES

FIG. 1 is a block diagram illustrating an exemplary architecture of a geodesically-constrained latent expansion network comprising encoding, expansion, attention, tunneling, harmonization, and dreaming subsystems.

FIG. 2 is a flow diagram illustrating an exemplary geodesic expansion process that extends trajectories beyond encoded boundaries using constrained variational optimization and spectral regularization.

FIG. 3 is a flow diagram illustrating an exemplary hierarchical multi-scale navigation process that enables infinite zoom across nested latent submanifolds with semantic consistency.

FIG. 4 is a flow diagram illustrating an exemplary geodesic attention field evolution process that models attention as a continuous vector field guiding expansion toward salient features.

FIG. 5 is a flow diagram illustrating an exemplary cross-manifold tunneling process that maps trajectories between distinct latent spaces while preserving curvature and semantic anchors.

FIG. 6 is a flow diagram illustrating an exemplary adaptive dreaming cycle process that perturbs, compresses, and generalizes trajectories offline to cache reusable expansion strategies.

FIG. 7 is a flow diagram illustrating an exemplary correlation network harmonization process that resolves inconsistencies across multiple trajectories to produce a consensus expansion.

FIG. 8 is a flow diagram illustrating an exemplary manifold energy budgeting process that allocates finite computational resources to expansions through dynamic evaluation and reallocation.

FIG. 9 is a flow diagram illustrating an exemplary counterfactual expansion process that perturbs baseline trajectories to generate geometrically and semantically valid alternate video reconstructions.

FIG. 10 illustrates an exemplary computing environment on which an embodiment described herein may be implemented.

### DETAILED DESCRIPTION OF THE INVENTION

The inventor has conceived and reduced to practice a system and method of video reconstruction using geodesically-constrained latent expansion networks. The system, in an embodiment, comprises a set of software-encoded components and one or more computing devices configured to reconstruct, augment, or extend video data by operating on latent representations structured as differentiable manifolds. Within this system, video content is encoded into a curved latent space governed by a Lorentzian metric structure, where each latent point retains spatiotemporal structure and causal orientation. The system utilizes a geodesic expansion mechanism that extends encoded video trajectories along mathematically valid paths determined by minimizing a constrained action functional over the latent manifold. This mechanism enables the generation of high-resolution and semantically coherent content beyond the originally encoded resolution boundaries.

The latent expansion process proceeds through variational minimization of an energy functional defined over the latent manifold, wherein the integrand comprises kinetic energy of latent traversal, curvature-induced compression pressure, and a goal potential field. The system computes optimal latent expansion paths that respect the intrinsic curvature of the manifold while aligning with attractor fields representing semantic, task-specific, or attention-driven objectives. More formally, geodesic expansion may be governed by the minimization of a cognitive action functional:

$$S [ γ ] = {\int }_{0}^{T} ( {‖ \dot{γ} ( t ) ‖}_{g}^{2} + P ( γ ( t ) ) - Φ ( γ ( t ) ) ) dt$$

$$where {‖ \dot{γ} ( t ) ‖}_{g}^{2} = {g}_{i j} {\dot{γ}}^{i} {\dot{γ}}^{j}$$

encodes path smoothness under the latent manifold metric g, P(γ(t)) represents compression pressure derived from Ricci curvature, and Φ(γ(t)) is a semantic goal potential field. The optimal trajectory γ*(t) satisfies the Euler-Lagrange equation:

$${\ddot{γ}}^{k} + {Γ}_{i j}^{k} {\dot{γ}}^{i} {\dot{γ}}^{j} = - {g}^{k l} ( {\partial }_{l} P - {\partial }_{l} Φ )$$

ensuring that expansion evolves in accordance with the manifold's differential geometry and extrinsic semantic influences.

Latent representations are further decomposed spectrally through eigenfunctions of the Laplace-Beltrami operator defined over the latent manifold. By projecting expansion dynamics into this spectral basis, the system separates low-frequency components that encode macro-level semantic structure from high-frequency components associated with fine-grained detail. A spectral cutoff λ_{c} may be enforced to regulate expansion:

$${Δ}_{g} {f}_{λ} = λ {f}_{λ}$$

thereby filtering out components above a designated frequency threshold to suppress incoherent or visually implausible detail.

The latent space is hierarchically structured into nested submanifolds corresponding to distinct semantic resolutions. A top-level manifold encodes macrostructures such as scene layout and object groupings, while mid- and micro-level manifolds encode object-specific features and texture-level representations. Transitions between these layers are governed by projection and lifting operators π:H_{micro}→H_{macro} and i:H_{macro} [symbol] H_{micro}, allowing the system to navigate across levels of abstraction during continuous zoom operations. The system computes geodesic trajectories across the hierarchy by solving:

$${γ}^{*} ( t ) = arg {min}_{γ} {\int }_{0}^{T} ( {g}_{ij} {\dot{γ}}^{i} {\dot{γ}}^{j} + λ {‖ π ( γ ( t ) ) - {γ}_{m a c r o} ‖}^{2} ) d t$$

thereby ensuring that expansion into higher-resolution regions remains semantically consistent with their lower-resolution projections.

During expansion, the system models attention as a continuous vector field A(x,t) defined over the latent space. This field evolves dynamically according to:

$$\frac{\partial A}{\partial t} + {∇}_{A} A = - ∇ ( P - Φ )$$

treating attention as a flow constrained by compression pressure and semantic objectives. The system generates detail preferentially along streamlines of the attention field, aligning perceptual saliency with generative synthesis.

In some embodiments, the system supports reconstruction across multiple latent manifolds, each corresponding to distinct sensing modalities, perspectives, or collaborative processing instances. Tunneling operators T:U∪M_{A}→V⊂M_{B} are defined such that, for a geodesic γ_{A}(t) in M_{A}, its mapped trajectory γ_{B}(t)=T(γ_{A}(t)) in M_{B} satisfies:

$$‖ {∇}_{B} {\dot{γ}}_{B} {\dot{γ}}_{B} ‖ \leq \vert \vert {∇}_{A} {\dot{γ}}_{A} {\dot{γ}}_{A} ‖ + ε$$

where ε is a tolerance parameter. Anchor alignment constraints further ensure semantic consistency across mapped regions.

The system supports the generation of counterfactual video sequences through tangent-space perturbation of baseline latent trajectories. A base trajectory γ(t) may be perturbed as:

$${γ}^{′} ( t ) = γ ( t ) + δ , δ ∈ {T}_{γ ( t )} M$$

with δ chosen according to curvature regularization and semantic anchor constraints. These perturbations allow the system to explore alternate scene outcomes while maintaining manifold consistency.

Latent expansions are decoded into video frames through a correlation-based refinement network, which aligns expanded latent sequences to ensure spatial, temporal, and semantic coherence. A consensus trajectory \hat{γ}(t) is computed as:

$$\hat{γ} ( t ) = C ( {γ}_{1} ( t ) , {γ}_{2} ( t ) , … , {γ}_{N} ( t ) )$$

where C is a correlation network trained to minimize a compound loss:

$$L = α {L}_{r e c} + β {L}_{g e o} + γ {L}_{temp} + δ {L}_{s e m}$$

capturing pixel-level reconstruction accuracy, geodesic conformity, temporal smoothness, and semantic consistency, respectively.

To ensure bounded computational complexity and avoid uncontrolled generative expansion, the system manages a latent energy budget for each expansion process. Each trajectory γ(t) is assigned an energy cost:

$$E [ γ ] = {\int }_{0}^{T} ( {‖ \dot{γ} ( t ) ‖}_{g}^{2} + {λ}_{1} P ( γ ( t ) ) + {λ}_{2} {‖ \ddot{γ} ( t ) ‖}^{2} ) d t$$

where the terms represent kinetic cost, compression pressure, and curvature penalty, respectively. A trajectory is admissible if E[γ]≤Eₘₐₓ, with budget reallocation strategies available to prioritize task-relevant dimensions.

Offline, the system enters a dreaming phase, wherein it simulates latent expansions by perturbing, compressing, and interpolating prior trajectories. These simulated expansions are evaluated for stability and utility, with successful patterns retained in a strategy cache for future reuse. The system may also reorganize manifold topology during dreaming, establishing new tunnels or bridges between frequently traversed regions to optimize future expansion performance. In some embodiments, these reorganizations are based on observed trajectory convergence, anchor alignment, or cross-manifold correspondence patterns.

The described system may be implemented in standalone or federated configurations, supporting both single-device deployments and distributed cognitive collaboration across multiple agents. In a federated scenario, each instance maintains its own latent manifold and expansion history, while tunneling and anchor alignment protocols enable cooperative reconstruction and counterfactual synthesis. This enables cross-perspective reconstruction in multi-agent video analysis, multi-sensor environments, and collaborative virtual spaces. Throughout all embodiments, the system maintains semantic fidelity, temporal consistency, and computational efficiency by operating strictly within the constraints imposed by differential geometry, spectral control, and manifold energy management.

In practice, the system operates as a cooperative latent engine that synthesizes video in a way that reflects both structural detail and narrative coherence. A typical interaction begins with compressed or partially rendered input video, which is mapped into a manifold representation where spatial, temporal, and semantic patterns are preserved. The user, whether human or automated, initiates an action such as zooming into a region, seeking a counterfactual alternative, or requesting synthesis of occluded elements. In response, the system determines a path through latent space that is geometrically smooth, semantically valid, and energetically feasible. This path defines how new video frames will be generated.

At each moment in this process, prior latent representations, user-defined or system-inferred goals, and encoded attention flows all shape the expansion trajectory. For instance, if a user follows the motion of a particular object, the system computes attention-aligned geodesics that guide expansion toward that object across time. These paths are informed by latent curvature and weighted by semantic potential, ensuring that what is generated remains consistent with the logic of the original video.

If multiple agents or sensors contribute to the reconstruction task, their latent spaces remain distinct but interlinked through topological mappings. A manifold representing thermal imagery, for example, may tunnel into one representing RGB video, enabling reconstruction of occluded detail. In collaborative contexts, separate users may issue independent queries-such as one zooming into a vehicle while another investigates the surrounding area- and the system reconciles these perspectives by aligning their respective expansions across the manifold topology.

When counterfactuals are requested, such as exploring how a scene might unfold under different assumptions, the system introduces perturbations in the tangent space of the latent trajectory. These modifications generate alternate video evolutions while preserving visual and causal coherence. All outputs are refined through correlation networks that align multiple expansions into a single coherent reconstruction. These mechanisms-expansion, attention, tunneling, correlation, and energy budgeting-operate in concert, ensuring the generated video not only looks plausible but remains grounded in the geometry and semantics of the source material.

Through this framework, the system transforms traditional video playback and enhancement into a form of structured latent navigation, where each frame reflects not just a decoded pixel state but the outcome of mathematically governed exploration through space, time, and meaning.

In a non-limiting use case example of a geodesically-constrained latent expansion network, a law enforcement analyst reviews surveillance footage of a crowded urban intersection captured from an elevated camera position mounted on a traffic signal pole. The original video was recorded at moderate resolution with a wide field of view to monitor general traffic patterns, capturing vehicles, pedestrians, and building facades across approximately two city blocks. During review, the analyst identifies a suspicious interaction between two individuals near a parked vehicle and requires closer examination of facial features, hand gestures, and objects being exchanged to determine whether criminal activity occurred.

The analyst initiates a zoom operation targeting the region containing the two individuals. The surveillance video is encoded by a Lorentzian encoding engine that compresses the spatiotemporal content into a curved latent manifold representation preserving causal temporal relationships and spatial structure. The compressed representation is organized by a hierarchical latent structure manager into nested submanifolds corresponding to macro-level scene layout including street geometry and building positions, meso-level features including vehicle outlines and pedestrian clusters, and micro-level details including facial features and hand positions that were not fully resolved in the original sensor capture.

As the analyst zooms into the region of interest, a geodesic expansion controller computes optimal expansion trajectories extending beyond the originally encoded resolution boundaries. The controller solves a constrained variational optimization problem minimizing a cognitive action functional that balances kinetic energy representing smooth latent traversal, compression pressure derived from manifold curvature that resists expansion into geometrically strained regions, and semantic goal potential fields that attract expansion toward perceptually salient features including human faces and hand-held objects. The geodesic expansion proceeds along mathematically valid paths through the latent hierarchy, transitioning from macro-level street scene representations through meso-level pedestrian group structures to micro-level facial and hand detail generation.

A geodesic attention field generator models the analyst's focus as a continuous vector field evolving over the curved latent manifold according to fluid dynamics principles. The attention field is initialized from the analyst's viewport position and zoom trajectory, creating attractive forces toward the target individuals while compression pressure from surrounding manifold regions creates repulsive forces away from less relevant background elements. The geodesic expansion trajectories align with streamlines of this attention field, ensuring that computational resources and detail generation capacity are preferentially allocated to the faces and hands of the two individuals rather than uniformly across the entire frame.

During expansion, spectral decomposition separates the generative process into low-frequency semantic components that ensure the generated faces maintain anatomically plausible proportions and expressions consistent with the surrounding context, and high-frequency detail components that synthesize skin texture, eye detail, and hand structure. A spectral cutoff prevents expansion into incoherent high-frequency noise that would produce visual artifacts. An energy budgeting system evaluates the computational cost of the expansion trajectory and determines that generating fine facial detail for both individuals simultaneously would exceed available real-time processing capacity. The system reallocates energy budget from background region processing to the high-priority facial regions, accepting reduced detail synthesis in the street and building facades to maintain smooth interactive zoom performance.

As the zoom reaches micro-level resolution revealing facial features that extend beyond the sensor's original capture capabilities, a correlation network harmonizer ensures temporal and semantic coherence across the expanded video sequence. The network receives multiple candidate expansion trajectories representing different hypotheses about facial appearance and hand positioning, applies attention-weighted similarity metrics to identify consistent features across candidates, and generates a consensus reconstruction that maintains frame-to-frame temporal smoothness while respecting symbolic anchors including known anatomical constraints and lighting consistency with the surrounding scene.

The analyst observes the expanded video and identifies that one individual appears to be handing a small rectangular object to the other individual. To explore whether this object could be a different item than initially assessed, the analyst requests counterfactual expansion showing alternate plausible scenarios. The geodesic expansion controller applies tangent-space perturbations to the baseline expansion trajectory, generating three counterfactual video sequences showing the exchange involving a mobile phone, a wallet, and a small package respectively. Each perturbation is constrained by curvature regularization ensuring the alternate trajectories remain geometrically valid within the manifold structure, and by semantic anchor coherence requirements ensuring that object sizes, hand positions, and exchange motions remain anatomically and physically plausible given the surrounding context.

The counterfactual sequences are decoded and presented to the analyst as side-by-side comparisons. The correlation network harmonizer ensures that all three counterfactual variations maintain consistent background elements, lighting conditions, and temporal progression, differing only in the specific object being exchanged and the associated subtle variations in hand positioning required to manipulate objects of different sizes and weights. This allows the analyst to evaluate which scenario appears most consistent with other evidence including hand grip patterns and subsequent behavior of the individuals after the exchange.

During a subsequent shift when the surveillance system enters low-demand periods overnight, an adaptive dreaming subsystem activates to perform offline manifold reorganization. The subsystem retrieves the successful expansion trajectory used during the daytime analysis and applies perturbation flows adding stochastic variations to explore alternate expansion strategies that might have produced similar results with lower computational cost. Compression flows identify redundant trajectory segments where similar facial details were synthesized multiple times and collapse these into representative exemplars. Generalization flows interpolate between the successful zoom trajectory and other cached strategies for facial detail synthesis in crowded scenes, generating meta-strategies applicable to future similar scenarios.

The dreaming process identifies that expansions targeting human faces in outdoor urban environments with elevated camera perspectives follow recurring geometric patterns through the latent hierarchy. The adaptive dreaming subsystem creates a topological bridge in the manifold structure connecting the macro-level urban scene region directly to common micro-level facial feature regions, bypassing intermediate meso-level computations that proved unnecessary in multiple successful expansions. This bridge is cached as a reusable strategy indexed by scene type, camera angle, and target object category.

Several days later, a different analyst reviews footage from the same intersection camera examining a different incident. When this analyst initiates zoom operations targeting pedestrian faces, the geodesic expansion controller retrieves the cached strategy generated during dreaming and applies the pre-computed topological bridge, reducing expansion computation time by avoiding redundant traversal through intermediate hierarchical levels. The attention field generator similarly retrieves cached attention flow patterns for face-targeting operations in elevated urban camera views, enabling immediate alignment of expansion resources with salient facial features without requiring dynamic attention field evolution from initialization.

In an extended scenario involving multiple camera feeds, the surveillance system deploys cross-manifold tunneling to enhance reconstruction quality. The primary elevated camera feed is encoded into a first latent manifold representing RGB visible-light video captured from above, while a secondary ground-level camera operated by a nearby business is encoded into a second distinct latent manifold representing RGB video from a perpendicular perspective. A cross-manifold tunneling engine defines tunneling operators that map geodesic trajectories between these two manifolds while preserving curvature properties and maintaining semantic anchor alignment at shared reference points including building corners, vehicle positions, and pedestrian locations visible in both camera views.

When the analyst zooms into facial detail in the elevated camera view, the tunneling engine identifies that the ground-level camera provides superior resolution for certain facial features due to its closer proximity and different viewing angle. The engine maps the expansion trajectory from the elevated camera manifold through a tunneling operator into the ground-level camera manifold, retrieves complementary facial detail from the alternative perspective, and maps the enhanced trajectory back through an inverse tunneling operator. The correlation network harmonizer synthesizes the multi-perspective information into a consensus reconstruction that combines the elevated camera's view of head position and body context with the ground-level camera's superior facial feature resolution, producing a final expanded video sequence that exceeds the reconstruction quality achievable from either camera individually.

Throughout these operations, the geodesically-constrained latent expansion network maintains semantic fidelity by ensuring all generated content respects the differential geometric constraints of the latent manifold structure, temporal consistency by enforcing smooth geodesic trajectories and correlation-based frame alignment, and computational efficiency by operating within finite energy budgets and reusing cached strategies generated during adaptive dreaming phases. The system transforms surveillance video review from passive playback of sensor-limited footage into active exploration of a geometrically structured latent space where zoom, counterfactual analysis, and multi-perspective fusion enable analysts to extract information content beyond the original encoded boundaries while maintaining mathematical validity and perceptual plausibility.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “latent manifold” refers to a structured mathematical space in which compressed spatiotemporal video representations are organized according to geometric and semantic relationships, typically modeled using differential geometry.

As used herein, “geodesic trajectory” refers to a path within a latent manifold that minimizes a cognitive action functional subject to manifold geometry, compression pressure, and semantic goal potentials, representing an optimal expansion or navigation path.

As used herein, “cognitive action functional” refers to a variational energy expression that balances kinetic smoothness, compression pressure, and goal potentials to constrain latent expansions to semantically coherent and geometrically valid paths.

As used herein, “compression pressure” refers to a scalar or tensor field derived from manifold curvature, such as Ricci curvature, that represents resistance to expansion through regions of high semantic density or geometric complexity.

As used herein, “goal potential” refers to a scalar field defined over a latent manifold that encodes task objectives, user attention, or PCM-derived intent, and which attracts expansion trajectories toward semantically significant regions.

As used herein, “semantic anchor” refers to a reference point or feature in a latent manifold corresponding to a semantically significant frame, object, event, or concept, used to preserve semantic consistency across expansions or manifold transitions.

As used herein, “attention field” refers to a continuous vector field defined over a latent manifold whose evolution is governed by fluid-dynamics-like equations, directing generative resources toward perceptually or semantically salient regions.

As used herein, “cross-manifold tunneling” refers to a process of mapping trajectories between distinct latent manifolds corresponding to different sensing modalities, perspectives, or PCM instances while preserving curvature and anchor alignment.

As used herein, “adaptive dreaming” refers to an offline process performed during idle cycles in which prior trajectories are perturbed, compressed, interpolated, and generalized to reorganize the manifold and cache reusable expansion strategies.

As used herein, “manifold energy budget” refers to a finite computational resource allocation that limits expansion trajectories by evaluating kinetic, pressure, and curvature penalty terms to ensure feasible, bounded, and stable operation.

As used herein, “counterfactual expansion” refers to the generation of an alternate trajectory through latent space by applying structured tangent-space perturbations to baseline geodesics, producing hypothetical but geometrically and semantically valid video reconstructions.

As used herein, “Lorentzian autoencoder” refers to an encoder-decoder architecture that compresses and reconstructs spatiotemporal video tensors while preserving causal structure using a pseudo-Riemannian metric of signature (−, +, +, . . . , +).

As used herein, “spectral decomposition” refers to the representation of latent expansions in eigenfunctions of the Laplace-Beltrami operator, allowing separation of low-frequency semantic components from high-frequency detail components.

As used herein, “projection operator” refers to a mapping π:Hmicro→Hmacro that compresses fine-grained micro-level latent features into higher-level semantic abstractions while maintaining consistency with manifold geometry.

As used herein, “lifting operator” refers to a mapping i:Hmacro→Hmicro that expands coarse semantic representations into plausible micro-level detail consistent with manifold geometry.

As used herein, “geodesic zoom” refers to the process of navigating between hierarchical latent submanifolds by solving a constrained geodesic optimization problem that ensures semantic alignment across scale levels.

As used herein, “tunneling operator” refers to a transformation T that maps trajectories from one latent manifold to another while preserving curvature constraints and aligning symbolic anchors across manifolds.

As used herein, “symbolic anchor” refers to a semantically significant frame, object, event, or feature encoded in a latent manifold that serves as a reference point for maintaining semantic alignment during expansion, zoom, or tunneling.

As used herein, “correlation network” refers to a neural architecture configured to align and harmonize multiple expanded trajectories by minimizing a compound loss comprising reconstruction, geodesic conformity, temporal smoothness, and semantic coherence terms.

As used herein, “compound loss function” refers to a weighted combination of loss terms that enforce pixel-level reconstruction accuracy, geodesic conformity, temporal coherence, and semantic alignment across expanded trajectories.

As used herein, “meta-strategy” refers to an abstracted expansion approach generated through adaptive dreaming by interpolating or generalizing multiple successful trajectories, enabling reuse across diverse task contexts or scene types.

### Conceptual Architecture of a Geodesically-Constrained Latent Expansion Network for Video Reconstruction

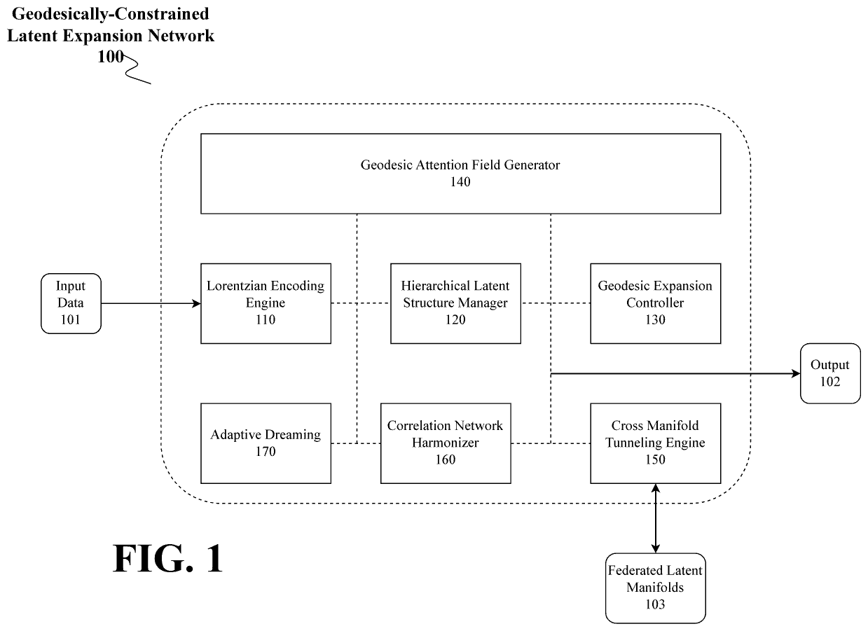

FIG. 1 is a block diagram illustrating exemplary architecture of a geodesically-constrained latent expansion network for video reconstruction and augmentation, in an embodiment. A geodesically-constrained latent expansion network system 100 as illustrated in this embodiment comprises seven integrated subsystems operating within a unified latent hyperspace manifold framework to enable coherent video content generation beyond originally encoded boundaries while maintaining semantic consistency and temporal coherence.

The illustrated architecture builds upon established approaches for adaptive latent space organization, geodesic navigation across curved manifolds, and cognitively supervised video processing. The system integrates content-aware compression that prioritizes spatiotemporal significance, trajectory computation that maintains coherence through differential geometric constraints, and supervisory controls that adapt processing based on contextual intent and collaborative interaction. In addition to supporting local operations, the architecture is configured to operate across federated instances of persistent cognitive systems, where multiple manifolds maintained by distributed agents or devices may exchange strategies, align semantic anchors, and coordinate expansion processes. By synthesizing these capabilities within a unified framework, the architecture advances beyond prior boundaries by enabling mathematically constrained latent expansion that supports coherent reconstruction, augmentation, and exploration of video content beyond the limits of the originally encoded representations.

System 100 receives spatiotemporal video input comprising video data streams that are processed through a core processing pipeline. A Lorentzian encoding engine 110 transforms input video tensors into compressed latent representations while preserving causal structure and geometric relationships through 3D convolutional encoder networks that maintain tensor structure and apply pseudo-Riemannian metric preservation with signature (−, +, +, +, . . . ). Lorentzian encoding engine 110 generates mini-Lorentzian representations organized as navigable geometric structures within a latent manifold, applying spectral decomposition to separate semantic coherence from fine detail components and computing compression pressure fields derived from Ricci curvature of the manifold geometry.

Compressed latent representations generated by Lorentzian encoding engine 110 are received by a hierarchical latent structure manager 120 that organizes representations into nested submanifolds supporting multi-scale operations. Hierarchical latent structure manager 120 maintains a nested submanifold architecture comprising macro-level, meso-level, and micro-level submanifolds, where each level corresponds to distinct semantic resolutions ranging from scene layout and object groupings at the macro level to texture-level representations at the micro level. Hierarchical latent structure manager 120 implements projection operators that compress representations from micro-level to macro-level submanifolds and lifting operators that expand representations from macro-level to micro-level submanifolds while maintaining semantic consistency across resolution transitions. Scale transition controllers within hierarchical latent structure manager 120 provide structured pathways for zoom operations that preserve semantic coherence across resolution levels.

Organized latent representations from hierarchical latent structure manager 120 are processed by a geodesic expansion controller 130 that extends latent trajectories beyond encoded boundaries using mathematically constrained optimization. Geodesic expansion controller 130 comprises a variational optimization engine that minimizes a cognitive action functional defined over latent trajectories, where the functional integrates kinetic energy terms representing path smoothness, compression pressure derived from manifold curvature, and semantic goal potential fields. An Euler-Lagrange equation solver within geodesic expansion controller 130 computes optimal geodesic paths that satisfy differential geometric constraints imposed by the manifold structure. Geodesic expansion controller 130 implements an energy budget allocation system that allocates finite cognitive energy across expansion operations to prevent uncontrolled generative drift, ensuring that each trajectory remains admissible by maintaining total energy cost below predetermined thresholds. A spectral decomposition framework within geodesic expansion controller 130 applies eigenfunctions of a Laplace-Beltrami operator defined over the latent manifold to separate low-frequency semantic components from high-frequency detail components during expansion, enabling frequency-based regularization through spectral cutoff enforcement.

System 100 further comprises advanced control systems that guide and constrain expansion processes. A geodesic attention field generator 140 models attention as continuous vector fields evolving over curved latent manifolds according to fluid dynamics equations rather than discrete token weightings. Geodesic attention field generator 140 generates attention vector fields that evolve according to differential equations where temporal evolution is constrained by compression pressure and goal potential gradients, treating attention flow as constrained by manifold geometry. Geodesic attention field generator 140 computes streamlines of attention vector fields and aligns geodesic expansion trajectories with these streamlines to ensure that detail generation occurs preferentially along perceptually salient features. Attention fields may be initialized from user attention maps, PCM-derived intent signals, saliency detection outputs, or historical interaction data, with successful attention strategies cached for reuse across semantically similar scenes or tasks.

A cross-manifold tunneling engine 150 enables communication between distinct latent manifolds through curvature-preserving mappings that support federated reconstruction and multi-perspective analysis. In an embodiment, cross-manifold tunneling engine 150 exchanges geodesic trajectory information with other latent manifolds 103, enabling system 100 to incorporate representations from additional sensors, perspectives, or distributed cognitive instances into the expansion process while maintaining curvature and semantic alignment. Cross-manifold tunneling engine 150 defines tunneling operators that map geodesic trajectories between distinct latent manifolds while preserving curvature properties through constraints that bound the difference in covariant derivatives across manifolds. Cross-manifold tunneling engine 150 implements symbolic anchor alignment protocols that maintain semantic consistency across mapped regions by ensuring that semantically corresponding features in different manifolds remain aligned under tunneling transformations. Homology-preserving mapping functions within cross-manifold tunneling engine 150 maintain topological relationships across manifold transitions, enabling applications including multi-sensor fusion across RGB, infrared, and LiDAR modalities, adversarial perspective analysis for BLUE and RED force scenarios, and federated communication between PCM instances operating on separate data sources. In an embodiment, cross-manifold tunneling engine 150 further enables cooperation across federated instances of a persistent cognitive machine, wherein trajectories from multiple distributed manifolds maintained by different agents or devices may be aligned through curvature-preserving mappings and anchor correspondences to support collaborative reconstruction and counterfactual exploration.

A correlation network harmonizer 160 ensures spatial, temporal, and semantic coherence across expanded latent trajectories by analyzing multiple expansion hypotheses and resolving inconsistencies. Correlation network harmonizer 160 receives multiple latent trajectories from geodesic expansion controller 130 and applies attention-weighted similarity metrics for alignment across trajectories. Graph-based message passing or transformer self-attention mechanisms within correlation network harmonizer 160 enforce inter-frame coherence, while diffusion kernel learning in latent space smooths across noisy or redundant expansions. Correlation network harmonizer 160 optimizes a compound loss function that combines pixel-level reconstruction accuracy, geodesic conformity penalties, temporal smoothness constraints, and semantic anchor coherence terms to generate consensus trajectories that maintain video continuity during zoom transitions, counterfactual synthesis, and multi-perspective fusion operations.

An adaptive dreaming subsystem 170 performs offline manifold reorganization and proactive expansion strategy generation through stochastic simulation, compression, and trajectory interpolation during idle processing periods. Adaptive dreaming subsystem 170 implements perturbation flows that add Gaussian or curvature-weighted noise to past trajectories to explore variations, compression flows that collapse redundant or low-information expansions to optimize storage efficiency, and generalization flows that interpolate between successful trajectories to form meta-strategies applicable across multiple task contexts. A topology editor within adaptive dreaming subsystem 170 adds or removes latent tunnels or bridges between frequently traversed manifold regions based on recurrent path analysis to optimize future expansion performance. Successful expansion strategies generated during dreaming phases are cached in a strategy library indexed by task class, attention context, or scene type, enabling zero-shot expansion or inference acceleration when real-time modules including geodesic expansion controller 130 and geodesic attention field generator 140 encounter similar contexts.

System 100 generates expanded video content by decoding latent trajectories computed along geodesic expansion paths while maintaining semantic coherence and temporal consistency through geometric constraints imposed by the latent manifold structure. Decoded video output from system 100 supports infinite zoom beyond original sensor resolution, counterfactual scenario synthesis exploring alternate scene evolutions, cross-domain generation across different sensing modalities or perspectives, and temporally coherent augmentation that preserves causal relationships across frame sequences. Through integration of Lorentzian encoding engine 110, hierarchical latent structure manager 120, geodesic expansion controller 130, geodesic attention field generator 140, cross-manifold tunneling engine 150, correlation network harmonizer 160, and adaptive dreaming subsystem 170, system 100 enables mathematically valid expansion of compressed video representations beyond encoded boundaries while maintaining real-time performance through geometric constraints, energy budgeting, and adaptive optimization.

In an embodiment, data flows through system 100 along multiple integrated pathways to transform input video into expanded reconstructed content. System input data 101 comprising spatiotemporal video tensors enters Lorentzian encoding engine 110 where video frames are compressed into causally-consistent latent representations that preserve temporal ordering and spatial relationships through pseudo-Riemannian geometric constraints. Encoded representations flow from Lorentzian encoding engine 110 to hierarchical latent structure manager 120 where they are organized across nested submanifolds at macro, meso, and micro scales, with symbolic anchors positioned at semantically significant manifold locations to serve as reference points for subsequent operations. Organized latent representations are transmitted to geodesic expansion controller 130 which computes optimal expansion trajectories by solving variational optimization problems subject to energy budget constraints, with spectral decomposition separating expansions into low-frequency semantic components and high-frequency detail components. Geodesic attention field generator 140 receives latent state information from geodesic expansion controller 130 and generates continuous attention vector fields that guide expansion along perceptually salient streamlines, while cross-manifold tunneling engine 150 enables parallel processing across multiple latent manifolds 103 when multi-sensor or multi-perspective data is present in system input data 101.

Expanded trajectories from geodesic expansion controller 130, potentially spanning multiple manifolds via cross-manifold tunneling engine 150, are processed by correlation network harmonizer 160 which aligns multiple trajectory hypotheses by applying attention-weighted similarity metrics and diffusion kernels in latent space to eliminate temporal discontinuities and semantic inconsistencies. Harmonized latent trajectories are decoded into video frame sequences that constitute system output data 102, which may include zoomed content beyond original resolution boundaries, counterfactual video sequences exploring alternate scene evolutions, or cross-domain synthesized content fusing multiple sensing modalities. Concurrently with real-time processing, adaptive dreaming subsystem 170 operates during idle periods to perturb, compress, and generalize successful expansion trajectories, caching optimized strategies that are subsequently available to geodesic expansion controller 130 and geodesic attention field generator 140 for accelerated processing of similar future inputs. Through this coordinated data flow, system 100 reconstructs and augments video content beyond encoded boundaries and unifies adaptive compression, multi-axis geodesic navigation, creating cognitively supervised control within a single latent expansion framework.

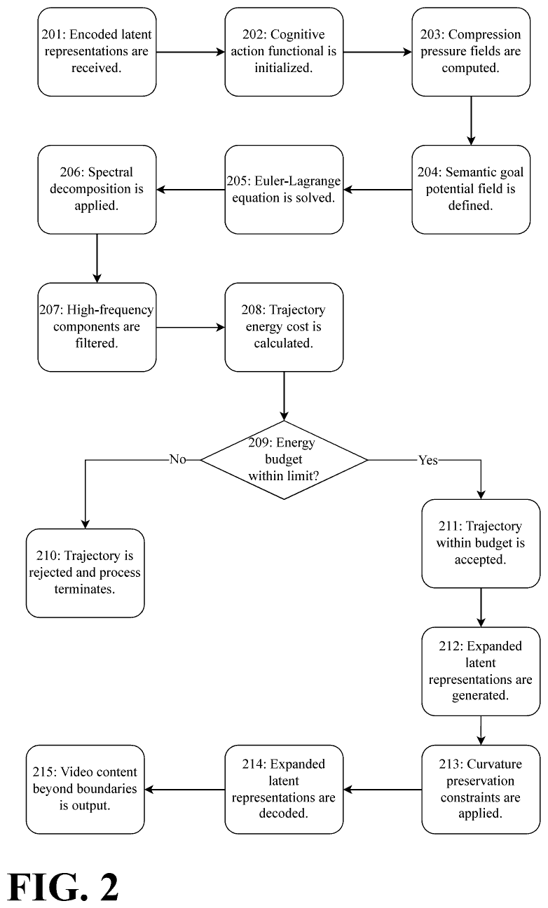

FIG. 2 is a flow diagram illustrating an exemplary geodesic expansion process of a geodesically-constrained latent expansion network, in an embodiment. The geodesic expansion process enables mathematically valid extension of latent trajectories beyond encoded manifold boundaries while maintaining semantic coherence and temporal consistency through constrained variational optimization. The process begins when encoded latent representations at manifold boundaries are received as input from Lorentzian encoding engine 110 and hierarchical latent structure manager 120, representing the current extent of compressed video content available for expansion 201. Geodesic expansion controller 130 then initializes a cognitive action functional with parameters defining the optimization problem, establishing the mathematical framework for computing geodesic trajectories that balance kinetic smoothness, geometric constraints, and semantic objectives 202. Within controller 130, compression pressure fields are computed from Ricci curvature of the latent manifold, quantifying how manifold geometry resists or facilitates expansion in different directions 203. A semantic goal potential field is next defined in coordination with geodesic attention field generator 140, encoding task-specific objectives, user attention targets, or PCM-derived saliency signals as a scalar field over the manifold to create attractive forces that guide expansion toward semantically meaningful regions 204. Controller 130 then solves the Euler-Lagrange equation to compute optimal geodesic trajectories that minimize the cognitive action functional subject to the manifold metric, compression pressure, and goal potential constraints, yielding candidate expansion paths through latent space 205. Spectral decomposition is applied using eigenfunctions of the Laplace-Beltrami operator defined over the latent manifold, separating the expansion into orthogonal frequency components that distinguish low-frequency semantic structure from high-frequency detail 206. High-frequency components above a spectral cutoff threshold are filtered to suppress incoherent or visually implausible detail that could introduce artifacts or semantic drift during expansion 207. Trajectory energy cost is then calculated by integrating kinetic energy of latent traversal, compression pressure penalties, and curvature smoothness terms that penalize abrupt directional changes in the expansion path 208. A determination is made whether the calculated trajectory energy remains within a predetermined budget that prevents uncontrolled generative expansion and maintains computational feasibility 209. If the energy exceeds the budget, the trajectory is rejected and expansion reverts to content within encoded boundaries, with the failed attempt recorded for offline dreaming or redirected through alternative manifolds in federated configurations, ensuring stability without uncontrolled generative drift 210. If the trajectory remains within budget, it is accepted for expansion 211.

Controller 130 generates expanded latent representations along the computed geodesic path, producing content that extends beyond the originally encoded manifold boundaries while following the mathematically constrained trajectory 212. Curvature preservation constraints are applied to ensure that the expanded trajectory maintains geometric validity within the manifold structure, preserving the pseudo-Riemannian signature and bounding sectional curvature deviations to retain temporal causality 213. The expanded latent representations are then decoded to video frames by a decoder network, which may comprise a 3D convolutional decoder augmented by correlation refinement layers from correlation network harmonizer 160 to ensure temporal alignment and semantic consistency across frames 214. The process concludes with output of video content beyond the original encoded boundaries as system output data 102, representing reconstructed or augmented sequences that extend beyond the resolution, temporal extent, or semantic scope of the input material while maintaining coherence through geodesic constraints 215.

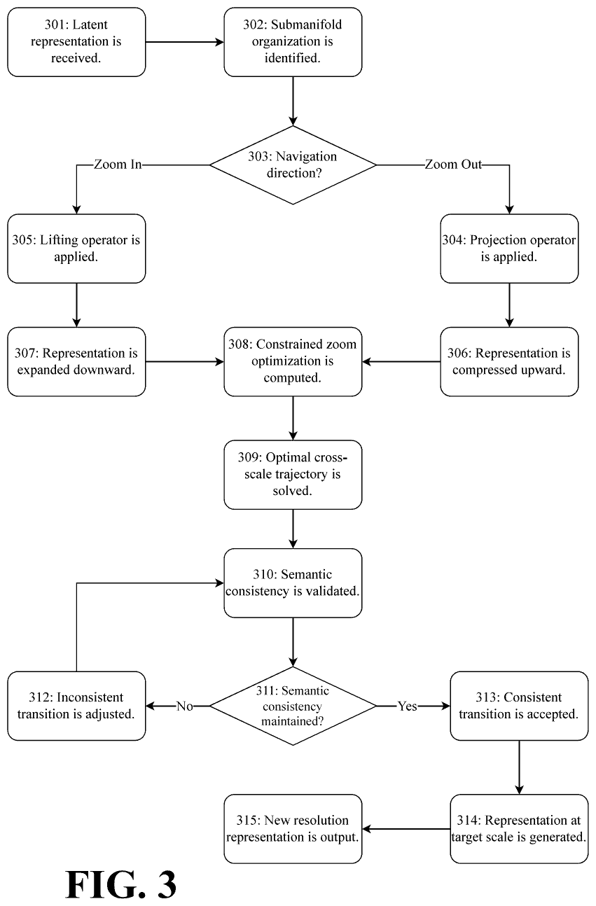

FIG. 3 is a flow diagram illustrating an exemplary hierarchical multi-scale navigation flow of a geodesically-constrained latent expansion network, in an embodiment. The hierarchical multi-scale navigation process enables infinite zoom operations across nested submanifolds while maintaining semantic consistency between different resolution levels through constrained optimization and geometric preservation. The process begins when a latent representation at a current scale level is received as input, which may be at any position within the hierarchical manifold structure including macro, meso, or micro resolution levels 301. Hierarchical latent structure manager 120 identifies the nested submanifold organization encompassing the current representation, determining its position within the hierarchy and the available adjacent scale levels for potential navigation 302. A determination is made regarding the intended navigation direction, specifically whether the operation requires zooming out toward higher-level abstractions or zooming in toward finer detail levels 303.

If the navigation direction is zoom out, hierarchical latent structure manager 120 applies a projection operator that compresses the representation from a micro-level submanifold toward a macro-level submanifold, reducing detail while preserving essential semantic structure 304. If the navigation direction is zoom in, hierarchical latent structure manager 120 applies a lifting operator that expands the representation from a macro-level submanifold toward a micro-level submanifold, generating additional detail consistent with the coarser representation 305. When projection is applied, fine-grained features are consolidated into broader semantic categories 306, and when lifting is applied, abstract features are elaborated into detailed structures 307.

Geodesic expansion controller 130 computes constrained zoom optimization that determines the optimal trajectory across scale levels by minimizing an objective function that balances geodesic smoothness in the latent space with a penalty term enforcing consistency between the current representation and its projection or lifting to adjacent scales 308. An optimal trajectory across scales is solved that satisfies both the geodesic constraints of the latent manifold geometry and the semantic alignment requirements between hierarchical levels 309. Correlation network harmonizer 160 validates the scale transition for semantic consistency by comparing the transformed representation against expected semantic properties at the target scale level 310. A determination is made whether semantic consistency has been maintained during the scale transition, verifying that essential semantic content is preserved despite changes in resolution or abstraction level 311.

If semantic consistency is not maintained, the transition is rejected and parameters including projection operator weights, lifting operator configurations, or optimization constraints are adjusted to improve alignment 312. Processing then returns to the constrained zoom optimization step with adjusted parameters to recompute the scale transition, and in some embodiments repeated failures are cached for adaptive dreaming subsystem 170 to refine strategy offline. If semantic consistency is maintained, the transition is accepted and processing continues 313. Hierarchical latent structure manager 120 generates a representation at the target scale, producing a latent encoding at the new resolution level that maintains geometric validity within the manifold structure, including preservation of Lorentzian signature and curvature bounds 314. A representation at a new resolution level is then output, enabling continued navigation, expansion, or decoding operations at the updated scale within the hierarchical manifold 315.

Through this hierarchical multi-scale navigation process, the system performs infinite zoom as constrained geodesic motion across nested latent submanifolds, ensuring that each transition preserves semantic fidelity, geometric validity, and temporal coherence while enabling expansion, reconstruction, or decoding at any resolution level.

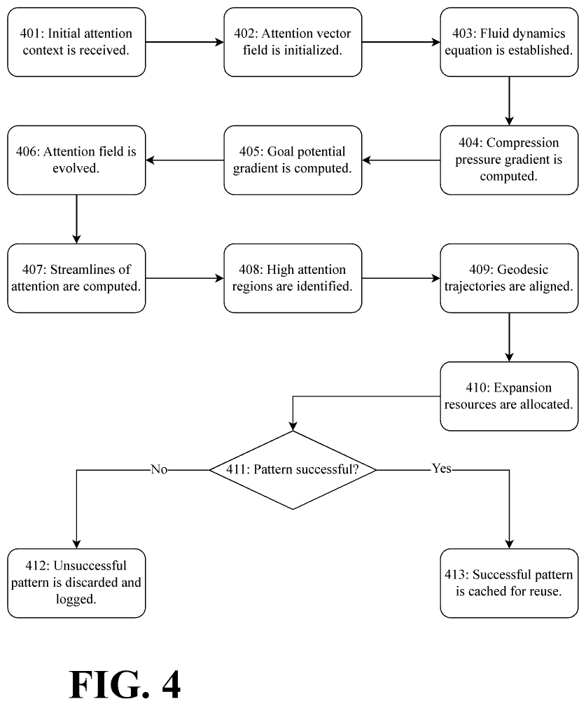

FIG. 4 is a flow diagram illustrating an exemplary geodesic attention field evolution flow of a geodesically-constrained latent expansion network, in an embodiment. The geodesic attention field evolution process models attention as a continuous vector field evolving over curved latent manifolds according to fluid dynamics principles, enabling saliency-guided expansion that aligns generative resources with perceptually or semantically relevant features. The process begins when initial attention context is received as input, which may originate from user attention maps, PCM-derived intent signals, saliency detection outputs, or historical interaction data indicating regions of interest within the latent manifold 401. Geodesic attention field generator 140 initializes an attention vector field over the manifold, establishing a continuous mapping from each point in the latent space to a vector representing attention direction and magnitude at that location 402.

A fluid dynamics evolution equation is established that governs temporal changes in the attention field, for example expressed as ∂A/∂t+∇ₐA=−∇(P−Φ), where A is the attention vector field, P is compression pressure, and Φ is goal potential 403. Geodesic attention field generator 140 computes the compression pressure gradient from the manifold curvature field, determining how geometric resistance to compression creates repulsive forces that influence attention flow away from highly curved regions 404. Geodesic attention field generator 140 computes the goal potential gradient from the semantic objective field, determining how task-specific or perceptual targets create attractive forces that draw attention flow toward semantically significant regions 405. The attention field is then evolved over time according to the dynamics equation, balancing advection along the field itself against the combined effects of compression pressure and goal potential gradients to produce temporally varying attention distributions 406.

Geodesic attention field generator 140 computes streamlines across the curved manifold geometry by integrating the attention vector field to produce continuous curves that remain tangent to the local attention direction 407. Regions of high attention flow are identified where streamline density, vector magnitude, or convergence patterns indicate concentrated perceptual or semantic significance 408. Geodesic expansion controller 130 incorporates attention field information into its variational optimization framework, aligning geodesic expansion trajectories with attention streamlines so that expansion paths are biased toward directions of high attention flow 409. Expansion resources including computational budget, decoder network capacity, and detail generation effort are then allocated preferentially along regions of high saliency, for example by increasing decoder attention weights or assigning greater energy budgets to paths aligned with attention streamlines 410.

A determination is next made whether the resulting attention pattern is successful by evaluating whether expansion guided by the field maintains semantic coherence, produces perceptually plausible results, or achieves task-specific objectives 411. If the attention pattern is not successful, the pattern is rejected and may be logged to adaptive dreaming subsystem 170 for offline analysis and refinement, ensuring that unsuccessful strategies still contribute to long-term system learning 412. If the attention pattern is successful, geodesic attention field generator 140 caches the strategy for reuse by storing field initialization parameters, evolution dynamics settings, and streamline configurations indexed by task class, attention context, or scene type, enabling accelerated processing of similar scenarios in the future 413.

Through this geodesic attention field evolution process, the system treats attention as a structured, geometry-constrained flow across latent manifolds, guiding expansion toward salient features, balancing generative resources, and preserving successful strategies for reuse to improve efficiency and coherence over time.

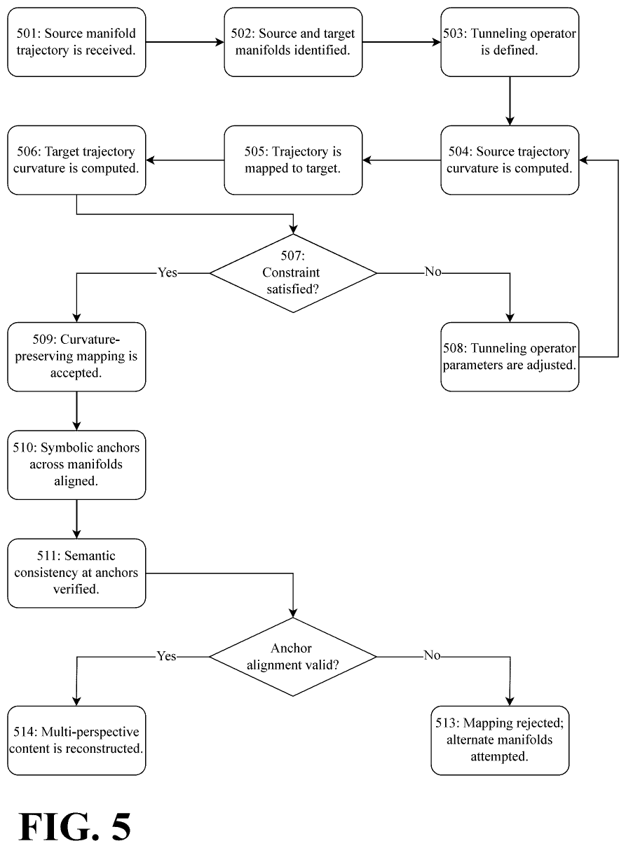

FIG. 5 is a flow diagram illustrating an exemplary cross-manifold tunneling operations flow of a geodesically-constrained latent expansion network, in an embodiment. The cross-manifold tunneling process enables communication between distinct latent manifolds through curvature-preserving mappings that support federated reconstruction, multi-sensor fusion, and multi-perspective analysis while maintaining geometric validity and semantic consistency across manifold transitions. The process begins when a geodesic trajectory in a source manifold is received as input, representing an expansion path computed within a first latent space corresponding to a particular sensing modality, perspective, or cognitive instance 501. Cross-manifold tunneling engine 150 identifies the source manifold and target manifold, determining the geometric properties including metric tensors and curvature characteristics of both latent spaces between which trajectory information will be exchanged 502. In some embodiments, the source and target manifolds may correspond to federated PCM instances, such that tunneling operators permit transfer of expansion strategies or reconstruction data across distributed cognitive systems while preserving curvature and semantic anchor constraints.

A tunneling operator is then defined, establishing a mapping function that transforms geodesic trajectories from the source manifold coordinate system to the target manifold coordinate system while preserving differential geometric properties 503. Cross-manifold tunneling engine 150 computes curvature properties of the source trajectory by evaluating covariant derivatives that measure how the trajectory's tangent vector changes as it moves through the source manifold geometry 504. The trajectory is mapped to the target manifold via the tunneling operator, applying the coordinate transformation to produce a corresponding trajectory in the target manifold's latent space 505. Curvature properties of the mapped trajectory are then computed in the target manifold by evaluating covariant derivatives to quantify any geometric deviation introduced by the tunneling transformation 506. A determination is made whether the curvature preservation constraint is satisfied by verifying that the norm of the covariant derivative in the target manifold does not exceed the norm in the source manifold by more than a tolerance parameter epsilon 507.

If the curvature preservation constraint is not satisfied, the mapping is rejected and the tunneling operator is adjusted by modifying transformation parameters, anchor point correspondences, or geometric correction terms to better preserve curvature properties 508. Processing then returns to the tunneling operator definition step with adjusted parameters to recompute the manifold mapping. If the curvature preservation constraint is satisfied, the mapped trajectory is accepted and processing continues 509. Cross-manifold tunneling engine 150 then aligns symbolic anchors across manifolds by establishing correspondences between semantically significant features in the source and target manifolds, ensuring that meaningful reference points such as object outlines or thematic concepts maintain consistent relationships under the tunneling transformation 510. Semantic consistency at anchor points is verified by comparing feature representations, object identities, or conceptual meanings at corresponding anchor locations to confirm that the tunneling preserves semantic relationships 511.

A determination is next made whether anchor alignment is valid by evaluating whether semantically corresponding features in different manifolds remain properly aligned under the tunneling operator 512. If anchor alignment is not valid, the mapping is rejected due to insufficient semantic correspondence and processing halts for that manifold pair, although alternate manifold combinations may be attempted in federated configurations 513. If anchor alignment is valid, cross-manifold tunneling engine 150 synthesizes multi-perspective reconstruction by integrating trajectory information from multiple manifolds to produce enhanced video content that combines information from diverse sensing modalities, viewpoints, or analytical perspectives 514.

Through this cross-manifold tunneling process, the system enables federated reconstruction and multi-sensor integration while maintaining geometric fidelity and semantic alignment, allowing expanded video content to combine complementary perspectives or modalities without introducing distortion or inconsistency.

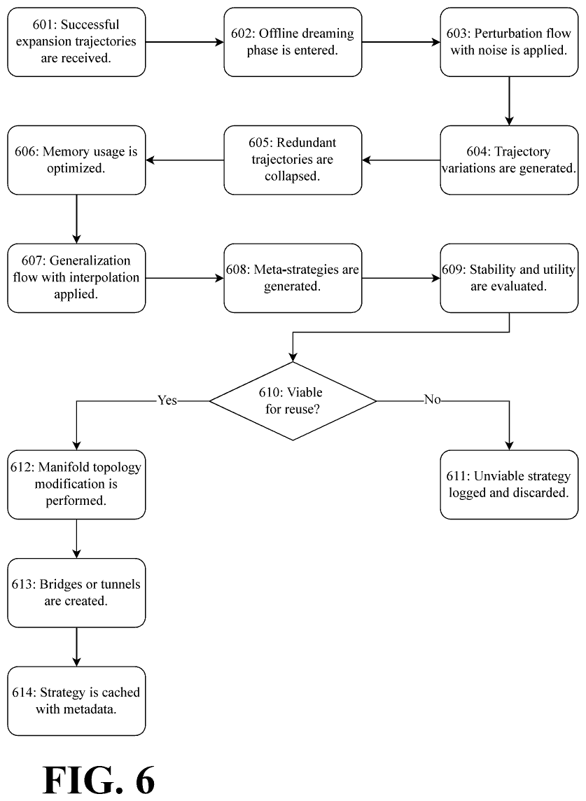

FIG. 6 is a flow diagram illustrating an exemplary adaptive dreaming cycle flow of a geodesically-constrained latent expansion network, in an embodiment. The adaptive dreaming process performs offline manifold reorganization and proactive expansion strategy generation through stochastic simulation, compression, and trajectory interpolation during idle processing periods, enabling accelerated real-time performance through cached meta-strategies derived from successful prior expansions. The process begins when recent successful expansion trajectories are received as input, comprising geodesic paths that have been validated through actual video reconstruction operations and demonstrated effective semantic coherence, temporal consistency, or task completion 601. Adaptive dreaming subsystem 170 enters an offline dreaming phase during idle periods when computational resources are not required for real-time video processing, allowing background optimization without impacting interactive performance 602.

A perturbation flow is applied with stochastic exploration, where adaptive dreaming subsystem 170 adds Gaussian noise or curvature-weighted perturbations to the successful trajectories to explore variations that may reveal alternative expansion strategies or improve robustness 603. Trajectory variations are generated through the perturbation process, creating multiple modified versions of each input trajectory that explore nearby regions of the latent manifold while maintaining approximate semantic validity 604. A compression flow is then applied to collapse redundancies by identifying trajectory variations that produce similar semantic outcomes or traverse equivalent regions of the manifold, consolidating these redundant paths to reduce storage requirements 605. Memory usage is optimized by eliminating low-information trajectory variants and compressing similar expansion patterns into representative exemplars, enabling efficient storage of strategy libraries 606.

A generalization flow is applied through trajectory interpolation where adaptive dreaming subsystem 170 combines multiple successful trajectories using weighted averaging or manifold geodesic interpolation to generate meta-strategies that capture common expansion patterns 607. Meta-strategies are thereby generated that represent abstracted expansion approaches applicable across multiple task contexts, scene types, or attention patterns rather than being specific to individual prior experiences 608. Strategy stability and utility are evaluated by testing whether the generated meta-strategies produce semantically coherent expansions when applied to held-out validation scenarios or synthetic test cases 609. A determination is made whether the strategy is viable for reuse by assessing whether it maintains geometric validity, produces perceptually plausible results, and demonstrates sufficient generality to apply beyond the specific trajectories from which it was derived 610.

If the strategy is not viable for reuse, the strategy is discarded but may be logged for later analysis of failure modes to inform subsequent dreaming cycles 611. If the strategy is viable for reuse, adaptive dreaming subsystem 170 modifies manifold topology if needed by analyzing trajectory patterns to identify frequently traversed regions that could benefit from direct connections 612. Bridges or tunnels are created between frequent regions by establishing new geometric pathways in the latent manifold that provide shortcuts for commonly executed expansion operations, reducing computational cost for future similar tasks 613. The strategy is cached in a library indexed by context, where adaptive dreaming subsystem 170 stores the meta-strategy with metadata including task class, attention context, scene type, or other relevant indexing information to enable rapid retrieval when geodesic expansion controller 130 or geodesic attention field generator 140 encounter similar future scenarios 614.

Through this adaptive dreaming cycle, the system consolidates past experience into optimized meta-strategies, reshaping manifold structure and caching reusable trajectories to accelerate future expansions while preserving semantic coherence and geometric validity.

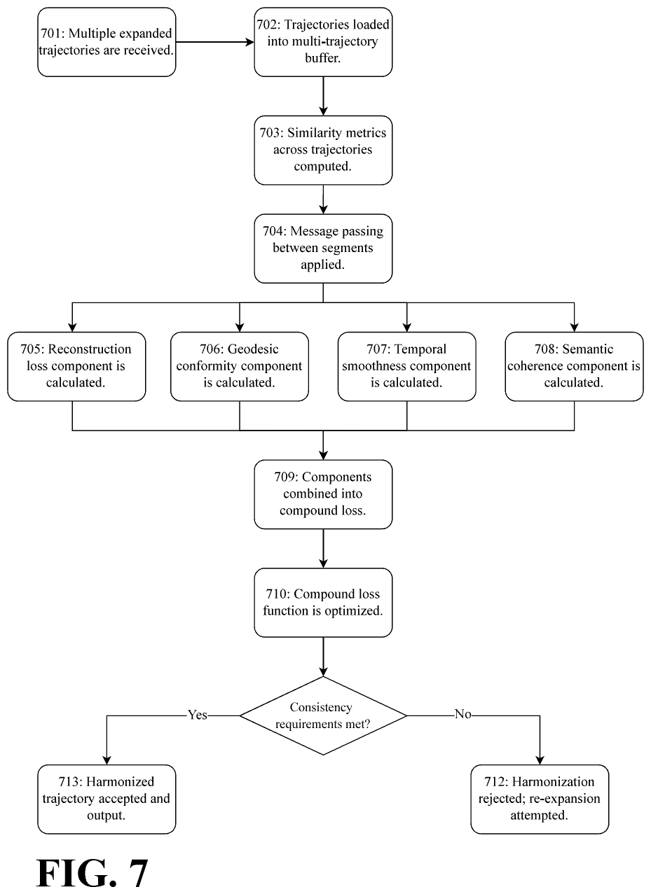

FIG. 7 is a flow diagram illustrating an exemplary correlation network harmonization flow of a geodesically-constrained latent expansion network, in an embodiment. The correlation network harmonization process ensures spatial, temporal, and semantic coherence across multiple expanded latent trajectories by analyzing divergent expansion hypotheses and resolving inconsistencies through multi-objective optimization that balances reconstruction accuracy, geometric validity, temporal smoothness, and semantic consistency. The process begins when multiple expanded trajectories are received as input, comprising distinct geodesic paths that may originate from different expansion hypotheses, counterfactual scenarios, sensing modalities, or parallel processing instances 701. Correlation network harmonizer 160 loads the trajectories into a multi-trajectory buffer that maintains temporal alignment and enables simultaneous processing of all candidate expansions for comparative analysis 702.

Similarity metrics are computed across trajectories by evaluating attention-weighted distances between corresponding latent representations at aligned temporal positions, quantifying the degree of agreement or divergence among expansion hypotheses 703. Message passing is then applied between trajectory segments using graph-based neural network architectures or transformer self-attention mechanisms, enabling information exchange across different expansion paths to identify consistent patterns and resolve conflicts 704. A reconstruction loss component is calculated that measures pixel-level accuracy when candidate trajectories are decoded to video frames, penalizing expansions that produce visually implausible or artifact-laden outputs 705. A geodesic conformity component is calculated that penalizes deviations from valid geodesic paths within the latent manifold geometry, ensuring expanded trajectories respect the differential geometric constraints of the underlying space 706. A temporal smoothness component is calculated that penalizes abrupt discontinuities or inconsistent motion patterns across consecutive frames, enforcing temporal coherence in the expanded video sequences 707. A semantic coherence component is calculated that measures consistency with symbolic anchors and semantic reference points distributed throughout the latent manifold, ensuring expanded content maintains meaningful relationships with encoded semantic structure 708.

The four loss components are combined into a compound loss function that weights reconstruction accuracy, geodesic conformity, temporal smoothness, and semantic coherence according to task-specific or context-dependent parameters 709. The compound loss function is optimized to generate a consensus trajectory that represents a harmonized expansion balancing the multiple objectives, using gradient-based optimization or closed-form solutions depending on the specific formulation 710. A determination is then made whether consistency requirements are met by evaluating whether the consensus trajectory satisfies predetermined thresholds for reconstruction quality, geometric validity, temporal coherence, and semantic alignment 711. If consistency requirements are not met, the harmonization is rejected and trajectories are returned for re-expansion with adjusted parameters or constraints to improve alignment 712. If consistency requirements are met, the harmonized trajectory is accepted and correlation network harmonizer 160 outputs the consensus expansion for subsequent decoding or further processing 713.

Through this correlation network harmonization process, the system resolves divergence among multiple candidate expansions by enforcing geometric, semantic, and temporal constraints, producing a unified consensus trajectory that maintains fidelity to the underlying manifold structure while ensuring video output remains perceptually coherent and semantically consistent.

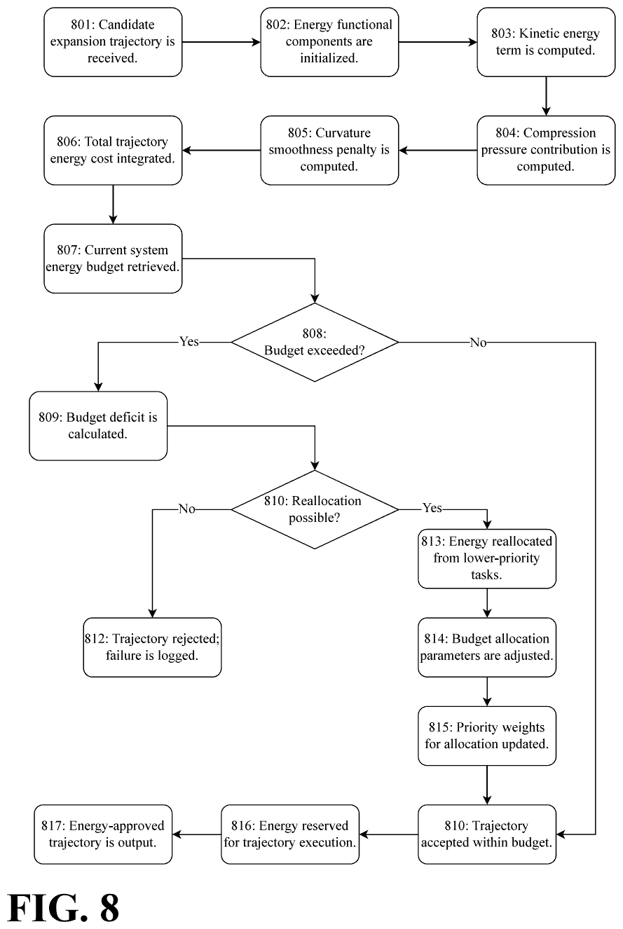

FIG. 8 is a flow diagram illustrating an exemplary manifold energy budgeting process of a geodesically-constrained latent expansion network, in an embodiment. The manifold energy budgeting process ensures tractable computation and prevents uncontrolled generative drift by treating expansion as a flow constrained by finite cognitive energy resources, with dynamic allocation and reallocation mechanisms that balance computational feasibility against reconstruction fidelity requirements. The process begins when a candidate expansion trajectory is received as input, representing a proposed geodesic path through latent space that requires energy cost evaluation before execution 801. Geodesic expansion controller 130 initializes energy functional components by establishing the mathematical framework for computing trajectory energy costs including kinetic, pressure, and curvature penalty terms with appropriate weighting coefficients 802.

A kinetic energy term is computed from trajectory velocity by evaluating the squared norm of the trajectory's tangent vector under the manifold metric, quantifying the energy cost of traversing the latent space at the proposed speed 803. A compression pressure contribution is computed from manifold curvature by evaluating the Ricci curvature field along the trajectory path and integrating the compression pressure penalty weighted by coefficient λ₁ 804. A curvature smoothness penalty is computed from trajectory acceleration by evaluating the squared norm of the second derivative of the trajectory, penalizing rapid directional changes that indicate abrupt transitions in latent space weighted by coefficient λ₂ 805. The total trajectory energy cost is then integrated by summing the kinetic energy term, compression pressure contribution, and curvature smoothness penalty over the temporal extent of the proposed expansion trajectory 806.

Geodesic expansion controller 130 retrieves the current system energy budget limit, which represents the maximum allowable energy expenditure for expansion operations based on available computational resources and performance requirements 807. A determination is made whether the trajectory energy exceeds the budget by comparing the integrated total energy cost against the current budget limit 808. If the trajectory energy exceeds the budget, geodesic expansion controller 130 calculates the budget deficit representing the additional energy resources that would be required to execute the proposed trajectory 809. If the trajectory energy does not exceed the budget, the trajectory is accepted within budget and processing proceeds to energy reservation 810.

A determination is then made whether budget can be reallocated from other operations by evaluating whether lower-priority expansion tasks, cached operations, or deferred computations can yield sufficient resources to cover the deficit 811. If budget cannot be reallocated, the trajectory is rejected due to insufficient energy and logged for potential offline dreaming analysis to refine future allocation strategies 812. If budget can be reallocated, geodesic expansion controller 130 reallocates energy from lower-priority operations by reducing allocations to tasks such as background dreaming processes, low-saliency region expansions, or deferred detail synthesis 813. Budget allocation parameters are adjusted by modifying the weighting coefficients and threshold values that govern future energy distribution decisions 814. Priority weights for future allocations are updated based on the current reallocation decision, implementing a learning mechanism that improves budget allocation strategies over time by favoring task categories that frequently require additional resources 815.

Geodesic expansion controller 130 reserves the allocated energy for trajectory execution by marking the approved energy quantity as committed to the specific expansion operation, preventing resource conflicts with concurrent processes 816. Finally, an energy-approved trajectory with reserved budget is output, enabling the expansion operation to proceed with guaranteed computational resources and ensuring that no mid-execution resource exhaustion occurs 817.

Through this manifold energy budgeting process, the system enforces computational discipline by evaluating, reallocating, and reserving finite energy resources, thereby ensuring that geodesic expansions remain both feasible and semantically coherent without destabilizing concurrent operations.

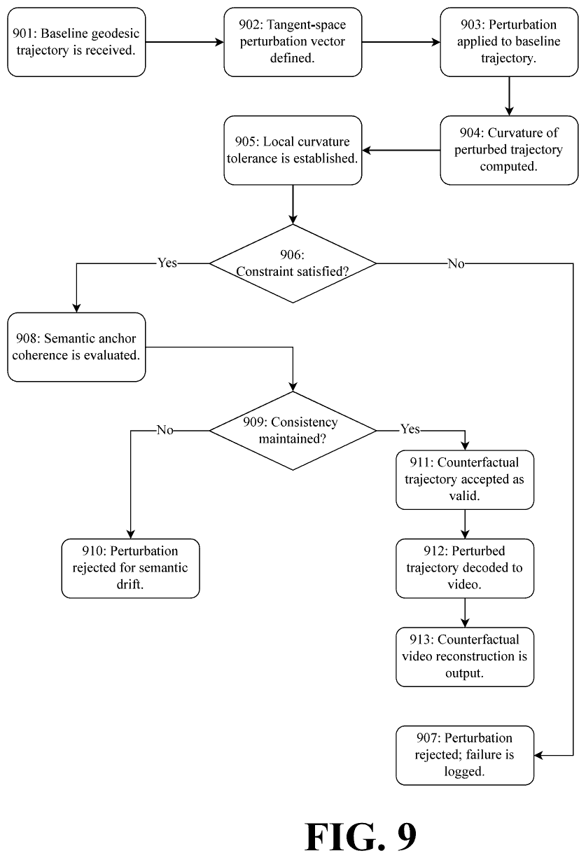

FIG. 9 is a flow diagram illustrating an exemplary counterfactual expansion process of a geodesically-constrained latent expansion network, in an embodiment. The counterfactual expansion process generates alternate but geometrically valid video reconstructions by perturbing latent trajectories in structured ways that answer hypothetical questions while maintaining semantic plausibility and temporal coherence through differential geometric constraints. The process begins when a baseline geodesic trajectory is received as input, representing the most probable and semantically coherent latent path that reconstructs an observed video sequence given the manifold's curvature, compression pressure, and goal potentials 901. Geodesic expansion controller 130 defines a perturbation vector in tangent space at a point along the baseline trajectory, where the perturbation vector represents a proposed deviation from the baseline path that remains embedded within the manifold's geometric structure 902. The perturbation is applied to the baseline trajectory by adding the tangent-space perturbation vector to produce a modified trajectory that explores alternate latent space regions while maintaining manifold validity 903.

Geodesic expansion controller 130 computes curvature of the perturbed trajectory by evaluating the covariant derivative of the trajectory's tangent vector, quantifying how rapidly the perturbed path deviates from geodesic smoothness 904. A curvature tolerance is then established from local Ricci curvature by computing a maximum allowable curvature threshold based on the manifold's intrinsic geometric properties at the perturbation location 905. A determination is made whether the curvature constraint is satisfied by verifying that the norm of the covariant derivative of the perturbed trajectory does not exceed the established curvature tolerance 906. If the curvature constraint is not satisfied, the perturbation is rejected as exceeding tolerance limits and may be logged for analysis by adaptive dreaming subsystem 170 to inform future perturbation strategies 907.

If the curvature constraint is satisfied, correlation network harmonizer 160 evaluates semantic anchor coherence by comparing the perturbed trajectory against symbolic anchors that encode semantically significant frames, objects, or events distributed throughout the manifold 908. A determination is made whether anchors maintain consistency by verifying that the perturbed path passes through or near required semantic reference points 909. If anchors do not maintain consistency, the perturbation is rejected due to semantic drift that would produce implausible or contextually inappropriate video content, and the failure may be logged for future refinement during offline dreaming cycles 910. If anchors maintain consistency, the counterfactual trajectory is accepted as a valid alternate expansion that satisfies both geometric and semantic constraints 911.

The accepted counterfactual trajectory is decoded to a counterfactual video sequence by passing the perturbed latent representations through decoder networks, with correlation-based refinement ensuring that temporal alignment and semantic coherence are preserved across frames 912. An alternate video reconstruction is then output, representing a hypothetical scenario such as motion alterations, environmental variations, or semantic substitutions that explore possibility space while maintaining temporal coherence and visual plausibility 913.

Through this counterfactual expansion process, the system generates alternate video reconstructions that remain grounded in manifold geometry and semantic structure, enabling exploration of hypothetical outcomes for applications in predictive analysis, simulation, forensic reconstruction, and training data augmentation while preserving semantic fidelity and geometric validity.

### Exemplary Computing Environment

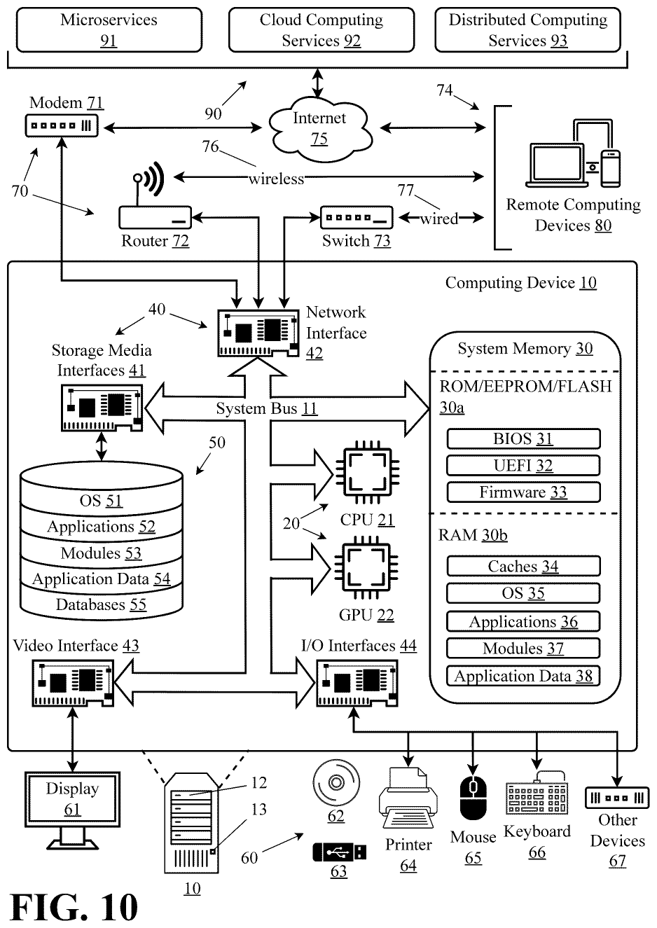

FIG. 10 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance. There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
receive spatiotemporal video input comprising video data streams;
encode the video input into compressed latent representations within a curved latent manifold using Lorentzian autoencoder processing that preserves spatiotemporal structure and causal relationships;
organize the compressed latent representations in a hierarchical manifold structure comprising nested submanifolds at multiple resolution scales;
compute geodesic expansion trajectories that extend beyond the encoded latent representations by solving a constrained variational optimization that minimizes a cognitive action functional comprising kinetic energy terms, compression pressure derived from manifold curvature, and semantic goal potential fields;
generate expanded video content by decoding latent trajectories computed along the geodesic expansion paths while maintaining semantic coherence and temporal consistency through geometric constraints imposed by the latent manifold structure;
manage computational resources through energy budgeting that allocates finite cognitive energy across expansion operations to prevent uncontrolled generative drift; and
provide real-time video reconstruction and augmentation configured to output reconstructed or augmented video streams including zoom beyond original resolution, counterfactual synthesis, and cross-domain generation.

2. The computer system of claim 1, wherein computing geodesic expansion trajectories comprises applying spectral decomposition using eigenfunctions of a Laplace-Beltrami operator defined over the latent manifold to separate low-frequency semantic components from high-frequency detail components during expansion.

3. The computer system of claim 1, wherein the hierarchical manifold structure comprises projection operators that compress representations from micro-level to macro-level submanifolds and lifting operators that expand representations from macro-level to micro-level submanifolds while maintaining semantic consistency across resolution transitions.

4. The computer system of claim 1, further configured to model attention as a continuous vector field A(x,t) evolving over the curved latent manifold according to fluid dynamics equations, wherein geodesic expansion trajectories are computed to align with streamlines of the attention vector field.

5. The computer system of claim 1, further configured to enable cross-manifold communication through tunneling operators that map geodesic trajectories between distinct latent manifolds while preserving curvature properties and maintaining semantic anchor alignment.

6. The computer system of claim 1, further configured to generate counterfactual video sequences by applying tangent-space perturbations to baseline geodesic trajectories, wherein perturbations are constrained by curvature regularization and semantic anchor consistency requirements.

7. The computer system of claim 1, further configured to perform offline manifold reorganization during idle periods by perturbing, compressing, and interpolating successful expansion trajectories to generate cached expansion strategies for accelerated real-time performance.

8. The computer system of claim 1, wherein the energy budgeting comprises computing trajectory energy costs that integrate kinetic energy of latent traversal, compression pressure penalties, and curvature smoothness terms, with trajectories accepted only when total energy cost remains below a predetermined threshold.

9. A computer-implemented method for video reconstruction using geodesically-constrained latent expansion networks, comprising:
receiving spatiotemporal video input comprising video data streams;
encoding the video input into compressed latent representations within a curved latent manifold using Lorentzian autoencoder processing that preserves spatiotemporal structure and causal relationships;
organizing the compressed latent representations in a hierarchical manifold structure comprising nested submanifolds at multiple resolution scales;
computing geodesic expansion trajectories that extend beyond the encoded latent representations by solving a constrained variational optimization that minimizes a cognitive action functional comprising kinetic energy terms, compression pressure derived from manifold curvature, and semantic goal potential fields;
generating expanded video content by decoding latent trajectories computed along the geodesic expansion paths while maintaining semantic coherence and temporal consistency through geometric constraints imposed by the latent manifold structure;
managing computational resources through energy budgeting that allocates finite cognitive energy across expansion operations to prevent uncontrolled generative drift; and
providing real-time video reconstruction and augmentation configured to output reconstructed or augmented video streams including zoom beyond original resolution, counterfactual synthesis, and cross-domain generation.

10. The method of claim 9, wherein computing geodesic expansion trajectories comprises applying spectral decomposition using eigenfunctions of a Laplace-Beltrami operator defined over the latent manifold to separate low-frequency semantic components from high-frequency detail components during expansion.

11. The method of claim 9, wherein the hierarchical manifold structure comprises projection operators that compress representations from micro-level to macro-level submanifolds and lifting operators that expand representations from macro-level to micro-level submanifolds while maintaining semantic consistency across resolution transitions.

12. The method of claim 9, further comprising modeling attention as a continuous vector field A(x,t) evolving over the curved latent manifold according to fluid dynamics equations, wherein geodesic expansion trajectories are computed to align with streamlines of the attention vector field.

13. The method of claim 9, further comprising enabling cross-manifold communication through tunneling operators that map geodesic trajectories between distinct latent manifolds while preserving curvature properties and maintaining semantic anchor alignment.

14. The method of claim 9, further comprising generating counterfactual video sequences by applying tangent-space perturbations to baseline geodesic trajectories, wherein perturbations are constrained by curvature regularization and semantic anchor consistency requirements.

15. The method of claim 9, further comprising performing offline manifold reorganization during idle periods by perturbing, compressing, and interpolating successful expansion trajectories to generate cached expansion strategies for accelerated real-time performance.

16. The method of claim 9, wherein the energy budgeting comprises computing trajectory energy costs that integrate kinetic energy of latent traversal, compression pressure penalties, and curvature smoothness terms, with trajectories accepted only when total energy cost remains below a predetermined threshold.
